(19) United States
(12) Patent Application Publication
(10) Pub. No.: US 2005/0193879 A1
(43) Pub. Date: Sep. 8, 2005

(54) Method and apparatus for high speed web processing incorporating linear tools with rotary motion

(76) Inventors: Bradley Champeau, Green Bay, WI (US); Paul D. Rauscher, De Pere, WI (US); Todd Hanson, Luxemburg, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/072,994

(22) Filed: Mar. 4, 2005

Related U.S. Application Data
(60) Provisional application No. 60/550,265, filed on Mar. 5, 2004.

(51) Int. Cl. B26D 1/00; B26D 3/00

(52) U.S. Cl. 83/13; 83/205; 83/218; 83/227; 83/669

(57) ABSTRACT

A method and apparatus for high speed web processing incorporating linear tools with rotary motion to provide the advantages of linear and rotary type processing as herein disclosed. The web processing apparatus of the present invention includes a pair of linear processing tools, a plurality of sets of rotary gears, a drive shaft coupled to a first set of rotary gears, and a plurality of brackets connecting the linear processing tools to the remaining sets of rotary gears. The drive shaft of the present invention drives movement of the linear processing tools at the same rate that a web to be processed moves in between the linear processing tools. Accordingly, the linear processing tools engage one another at a flat angle at a fixed position of the web to process the web. The present invention also discloses a method for high speed web processing wherein a pair of linear processing tools are bracketed to a plurality of rotary gears such that the linear processing tools rotate with the rotary gears. A pair of linear processing tools are aligned such that the upper and lower linear processing tools engage at a flat angle when the lower linear tool is at its uppermost position and the upper linear tool is at its lowest position. A web of material is guided in between the upper and lower linear processing tools at the same rate at which the linear tools are rotated. In this manner, a web of material is processed when the upper and lower linear processing tools engage the web at a flat angle.

### CROSS-REFERENCE TO RELATED APPLICATIONS

The present invention is entitled to the benefit of Provisional Application Ser. No. 60/550,265, filed Mar. 5, 2004.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND AND SUMMARY

In the production of paper, film, foil, laminate, plastic, vinyl, rubber, woven and non-woven material products, a continuous web of material is passed through an in-line apparatus to perforate, chip, punch, crease, stamp, cut or otherwise process the web material to form a product. The present invention is directed to a method and apparatus for processing a web of material at high speeds and particularly to a web processing apparatus and method incorporating linear tools with rotary motion for web processing at high speeds.

Reciprocating linear web processing systems are well known in the industry. In such systems, a web of material is intermittently fed between a pair of linear or flat-type processing tools. The linear processing tools reciprocate vertically to perforate, chip, punch, crease, stamp, cut or otherwise process the web material. The advantage of linear web processing systems is that the linear processing tools contact the web at a flat angle allowing for precise processing. However, the web of material must be stopped before the linear processing tools engage the web material; otherwise, linear tools will tear or otherwise damage the web during production. This results in inaccurate processing of the web of material since the web cannot always be stopped at the appropriate point. The result is processed forms of incongruent sizes that must be re-processed to achieve consistent, accurate processing results. Therefore, with linear type tooling, the web is processed at low speeds with continuous stoppages for processing. This is a significant production disadvantage as productivity steeply declines with the aforementioned continuous stoppages and corresponding inaccuracy.

In order to improve the rate at which the web is processed, rotary type processing systems became well recognized in the industry. In rotary systems, the tools do not contact the web at a flat angle as in the linear type tooling process. Instead, the tools in rotary type processing systems are relatively circular in construction and rotate with the web supply shafts. The rotation of the tools are synchronized to permit continuous processing of the web as it moves through the system. In rotary type systems, it is imperative to have axis parallelism between the tools and to provide a constant spacing between the tools that is accurately aligned and maintained in order to effectuate the proper relationship between the rotary tools and the web supply shaft for accurate and repeatable formation of the same process on the web.

The main drawback with rotary type tooling is that the rotary tools do not contact the web at a flat angle. Instead, the rotary tools approach the web tangentially and do not interact at a flat angle when processing. This angular interaction of the rotary type tooling and the web material creates severe wear or “scrubbing” on the rotary tools and also can amount to a large waste expense if a web is damaged or improperly processed due to worn rotary tools.

### BRIEF SUMMARY OF THE INVENTION

The present invention provides a combination of the advantages of linear type processing with rotary type processing. The present invention allows for the processing of a web at high speeds with the precision of flat angle processing of linear tools in conjunction with the accuracy and high rate of motion associated with rotary type systems. The method and apparatus of the present invention allows for the speed of the web to travel at the same speed as linear processing tools such that the web need not be stopped for linear processing. The present invention has the advantage of variable repeat processing, which is the ability to accurately vary the size of forms being processed on a web using the same machine on the same web of material. Further, the linear processing tools used in the present invention have easily changeable plates such that the machine can switch from one type of processing to another quickly and easily.

The advantages of the present invention are realized by a web processing apparatus having a plurality of sets of rotary gears, the sets of rotary gears each comprising rotary gears horizontally spaced from one another and stacked vertically to engage one another for coordinated movement. The apparatus further includes a drive shaft coupled to a first set of rotary gears, that first set of rotary gears is functionally connected to the remaining sets of rotary gears such that the drive shaft effects motion to the plurality of sets of rotary gears.

A linear processing tool having an upper member and a lower member, with the upper and lower members each having a processing surface is utilized in the present invention. The processing surface of the upper member is adapted to engage the processing surface of the lower member at a flat angle to process a web of material.

Preferably, a plurality of brackets connect the linear processing tool to the remaining sets of rotary gears. Particularly, an upper pair of brackets engages the upper member of the linear processing tool and a lower pair of brackets engages the lower member of the linear processing tool. The upper and lower brackets are connected to a second and third set of rotary gears. When the drive shaft drives the rotary motion of the plurality of sets of rotary gears, the rotary motion effects movement of the first set of gears in a first direction, the second set of gears in a second, opposite direction, and the third set of gears in the same, first direction as the first set of gears. The movement of the first and second sets of rotary gears effects movement of the upper and lower members of the linear processing tools in opposite directions relative to one another. The processing surfaces of the upper and lower members of the linear processing tool engage to process a web when the lower linear processing tool is at its uppermost position and the upper linear processing tool is at its lowermost position. A web guide is utilized to maintain the web of material at a precise vertical position for processing.

With respect to the method of the present invention, a web is fed into a guide mechanism which guides the web through the processing system on a horizontal plane at a precise vertical position. The processing system operates such that a plurality of linear tools are bracketed to a series of gears such that the gears rotate and cause the linear tools to rotate therewith. As the gears rotate, the plurality of linear tools rotate relative to one another. The system is arranged such that the linear tools will engage one another at the point where the web is guided through the system when a top linear tool is at the bottom of its rotation while the bottom linear tool is at the top of its rotation. The linear tools are aligned so that this interaction occurs. Importantly, the rate of the web moving through the processing system is also the rate of the rotation of the linear processing tools. Therefore, the processing tools engage the web and processes the web with the same horizontal velocity as the web passing therethrough, ensuring a precise and accurate web processing, while maintaining production at a favorable rate.

It is submitted that the processing interaction of the present invention may be achieved with several different types of tooling, bracketing, gear and crank combinations.

The above mentioned advantages, features and objects of the present invention will be further evident from the following detailed description and the accompanying drawings of the invention.

### BRIEF DESCRIPTION OF THE SEVERAL VIEWS OF THE DRAWINGS

Various alternatives and embodiments are contemplated as being within the scope of the following claims particularly pointing out and distinctly claiming the subject matter regarded as the invention.

### DETAILED DESCRIPTION OF THE INVENTION

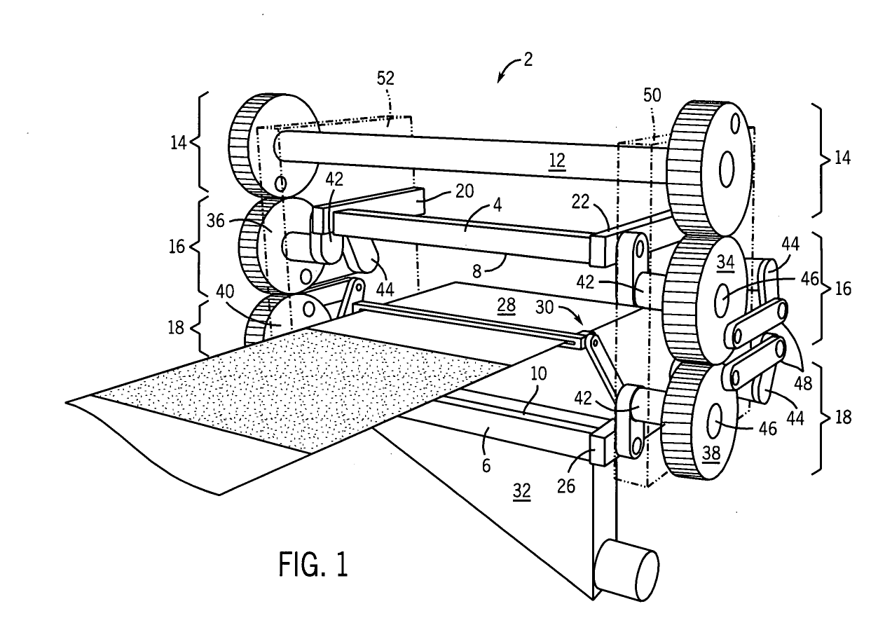

Referring now to FIGS. 1-3, the web processing apparatus 2 of the present invention comprises a linear processing tool further comprising an upper linear processing tool 4 and a lower linear processing tool 6. Both the upper tool 4 and the lower tool 6 have a processing surface, 8 and 10, respectively.

The web processing apparatus 2 further comprises a plurality of sets of rotary gears 14, 16, 18 engaging one another for coordinated movement. A drive shaft 12 is coupled to a first set 14 of the plurality of sets of rotary gears. The first set of rotary gears 14, when coupled to the drive shaft, effects movement of the remaining sets of rotary gears, 16 and 18. A plurality of brackets 20, 22, 24, 26 connect the upper and lower linear processing tools 8, 10 to the remaining sets of rotary gears 16, 18.

When the drive shaft 12 drives movement of the first set of rotary gears 14, movement of the second set of gears 16 and the third set of gears 18 are effected. Movement of gear sets 16 and 18 results in movement of brackets 20, 22, 24, 26, which in turn, imparts a rotational processing movement on the upper linear processing tool 4 and the lower linear processing tool 6 while maintaining a horizontal orientation of the processing surfaces 8 and 10. This movement results in the processing surface 8 of the upper linear processing tool 4 engaging the processing surface 10 of the lower linear processing tool 6 at a flat angle and at a fixed vertical position within the horizontal plane.

The system 2 operates such that a web 28 moves at a constant horizontal velocity through the linear tools 4, 6. Driven cylindrical rollers (not shown) are upstream and downstream of the apparatus 2. The driven cylindrical rollers drive the web at a constant speed. The web of material 28 is fed into the apparatus 2 at a precise vertical position with the horizontal plane and at a set velocity. The drive shaft 12 drives movement of the linear processing tools 4, 6 such that when the linear processing tools 4, 6 engage to process the web 28, the horizontal velocity of the tools 4, 6 matches the horizontal velocity of the web 28. The web of material 28 thus travels in the same horizontal plane through which the linear processing tools 4, 6 travel.

The web processing apparatus 2 may further comprise a web guide member 30 to guide the web 28 when severed by the processing tools 4, 6 in certain types of processing. In a preferred embodiment, the web guide member 30 maintains the web 28 in a horizontal plane between the pair of linear processing tools 4, 6 and guides the leading edge of a severed web to downstream driven cylindrical rollers (not shown). As the web guide member 30 maintains the web 28 in the horizontal plane in between the pair of linear processing tools 4, 6, the guide member 30 operates to guide the web to a precise vertical position relative to the lower tool 6. Thus, when the processing surface 8 of the upper linear processing tool 4 engages the processing surface 10 of the lower linear processing tool at the fixed vertical position, that vertical position is precisely the same vertical position at which the web is traveling in between the pair of linear processing tools 4, 6. Further, when the linear processing tools 4, 6 engage the web at this precise vertical position, the horizontal velocity of the linear tools 4, 6 matches the horizontal velocity of the web of material 28. In this manner, the system 2 of the present invention processes a web of material 28 at a constant rate with precise processing.

The apparatus 2 of the present invention is capable of variable repeat processing, as well as fixed repeat processing. Variable repeat processing refers to the ability to consistently process forms of different lengths as the web of material 28. In fixed repeat processing, the lengths of forms are not varied.

To control movement of the apparatus 2, a drive motor (not shown) is connected to the drive shaft 12. The motor drives the linear tool 4, 6, via the plurality of rotary gears 14, 16, 18, such that the linear processing tools 4, 6 engage the web of material at a precise vertical position such that the horizontal velocity of the linear tools 4, 6 matches the horizontal velocity of the web of material 28. The drive motor may be any type of electrical or other motor as is well known in the art. Preferably, the drive motor is a servo motor capable of receiving a programmed servo profile.

The apparatus 2 of the present invention, if driven at a constant speed, will drive a constant, repeating movement of the linear processing tools 4, 6. To ensure that the horizontal velocity of the linear tools 4, 6 matches the horizontal velocity of the web of material 28, the speed of the drive motor will have a linear relationship to the speed of the web of material 28 when driven at a constant speed. As the web speed increases or decreases, the drive motor will increase or decrease the rotational speed of the plurality of rotary gears 14, 16, 18 in linear relationship to the speed of the web. In this manner, the speed of the web 28 and corresponding speed of the apparatus 2 determines the length of form to be processed. Therefore, when the apparatus 2 is operating as a fixed repeat device (i.e., the length of form is not varied), the machine is driven at a constant speed which corresponds to a certain length of form. Fixed repeat processing does not require the use of a servo motor, and any type of motor may be used with the apparatus 2 of the present invention to effect fixed repeat processing on a web of material 28. However, it is required that the linear processing tools 4, 6 always engage the web of material at a precise vertical position such that the horizontal velocity of the linear processing tools 4, 6 matches the horizontal velocity of the web of material 28.

A user may also desire to use the apparatus 2 of the present invention to produce a large amount of fixed length forms over an extended period of time, but may also desire to change the length of the forms being processed so that a different length of forms may be produced over an extended period of time. The apparatus 2 of the present invention may then incorporate a servo motor to control the plurality of rotary gears 14, 16, 18 such that the linear processing tools 4, 6 engage the web of material at a precise vertical position with the horizontal velocity of the linear tools 4, 6 matching the horizontal velocity of the web of material 28. The servo motor may be programmed such that when the linear processing tools 4, 6 disengage the web of material 28, the servo motor drives the linear processing tools 4, 6 at the speeds determinative of the length of form a user desires to be produced. Thus, as the disengagement speed is varied, the lengths of the forms are varied. In this manner, a user can program the apparatus 2 of the present invention, via a servo profile, to produce a constant length of forms for an extended period of time while allowing the user to set the desired length of forms to be produced.

The apparatus 2 of the present invention is also capable of effecting true variable repeat processing. In variable repeat processing, the length of the forms may be varied with each subsequent form being produced. Thus, the servo motor may be programmed to disengage the web of material 28 at different speeds determinative of the length of the form a user desires to be produced. As the disengagement speed is varied, the lengths of the forms are varied. The user may program the servo profile of the servo motor to produce consecutive forms of desired varying lengths. Programming of the servo profile indicates to the servo motor at which speed the linear processing tools 4, 6 move when disengaged from the web to produce the desired forms of varying sizes. It must be emphasized that regardless of the length of forms to be produced and the speed at which the linear processing tools 4, 6 move when disengaged, the linear processing tools 4, 6 always engage the web of material at a precise vertical position such that the horizontal velocity of the linear processing tools 4, 6 matches the horizontal velocity of the web of material 28.

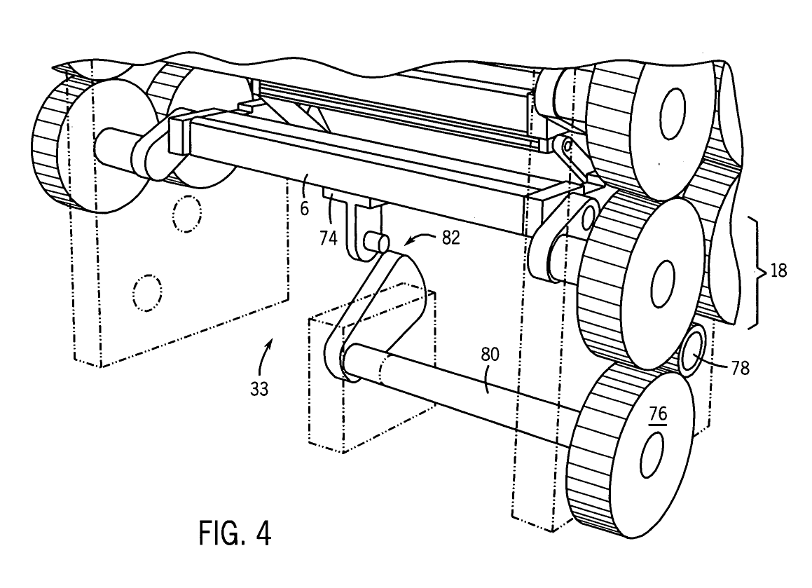

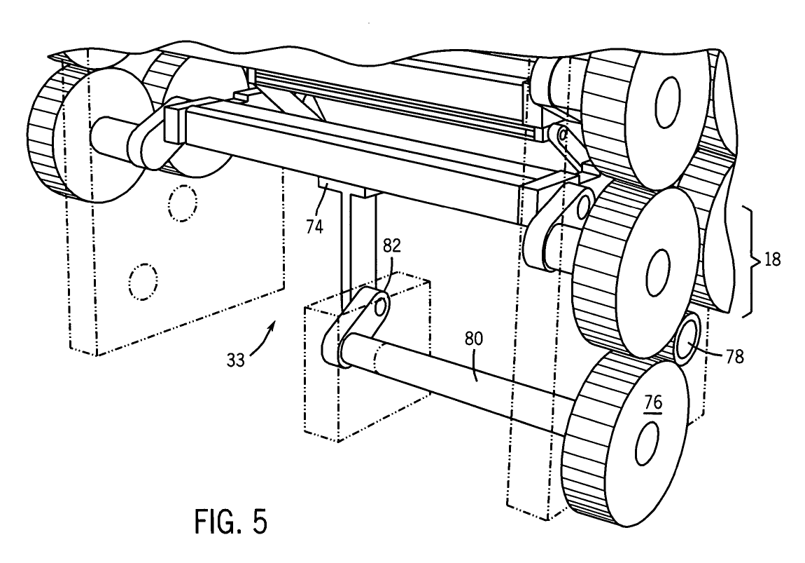

The web processing apparatus 2 of the present invention may further comprise a debris clean-up collection bin 32 to collect debris accumulated during the processing of the web of material 28. This collection bin 32 may or may not be connected to the linear tools 4, 6. Additionally, the web processing apparatus 2 of the present invention may further comprise a tooling support 33 for supporting either the upper linear processing tool 4 or lower linear processing tool 6. In FIGS. 4 and 5, the tooling support 33 is demonstrated as being associated with the lower linear processing tool 6 and is constructed for coordinated movement with the lower linear processing tool 6. The tooling support 33 provides the pair of linear processing tools, 4, 6, with an increased processing pressure for enhanced die cutting, foil stamping or other types of processing which require increased pressure. The inventors contemplate the capability of supporting either the upper 4 or lower 6 linear processing tools with a tooling support.

The processing surfaces 8 and 10 of the upper and lower linear processing tools are interchangeable. Specifically, the interchangeable processing surface 8 and 10 can incorporate a variety of plates to effect different types of processing on the web 28. Particularly, the types of plates utilized may include perforating plates, creasing plates, punching plates, cutting plates, creasing plates, stamping plates, chipping plates, die cutting plates, embossing plates, or foil stamping plates, among others. It is contemplated that many other types of interchangeable processing plates are compatible with the present invention and are deemed within the scope of the present invention. Incorporation of the interchangeable processing plates 8 and 10 allows the apparatus 2 to vary the types of processing on a continuous web of material using the same machine.

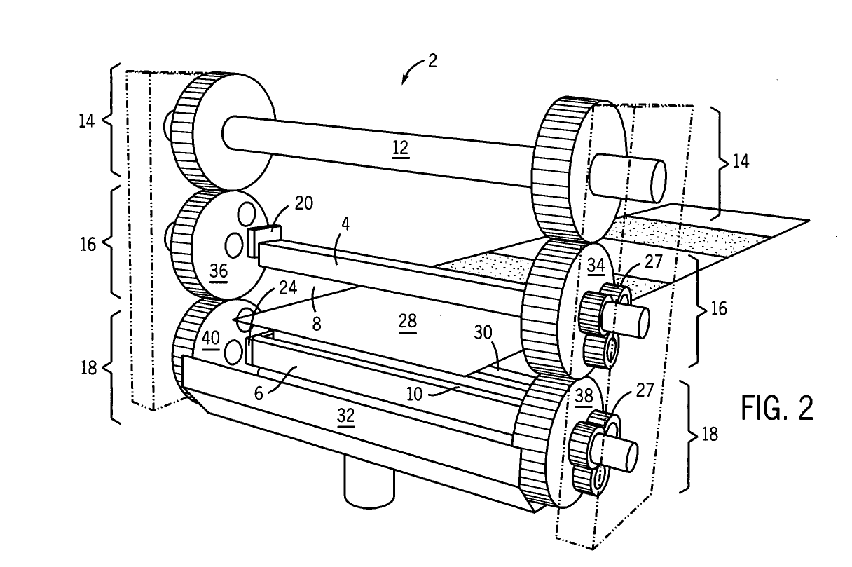

Referring now to FIGS. 1 and 2, the first pair of rotary gears 14 coupled to the drive shaft 12 are horizontally spaced from one another and connected by the drive shaft 12. The second set of rotary gears 16 further comprises a second pair of rotary gears 34 and 36, horizontally spaced from one another and connected to brackets 22 and 20, respectively. The second pair of rotary gears 34 and 36 are located vertically adjacent to and engage the first pair of rotary gears 14, such that the second pair of rotary gears 34, 36 rotate in an opposite direction as the first set of rotary gears 14. A third pair of rotary gears 38 and 40 are horizontally spaced from one another and connected to brackets 26 and 24, respectively. The third pair of rotary gears 38, 40 are located vertically adjacent to and engage the second pair of rotary gears 34, 36 such that the third pair of rotary gears 38, 40 rotate in an opposite direction as the second pair of rotary gears 34, 36 and in the same direction as the first set of rotary gears 14.

Brackets 22 and 20 which are connected to the second pair of rotary gears 34 and 36 retain the upper tool 4 of the linear processing tool and brackets 26 and 24, which are connected to the third pair of rotary gears 38, 40, retain the lower tool 6 of the linear processing tool. Thus, the upper tool 4 and lower tool 6 rotate with the rotary gears 34, 36 and 38, 40, respectively, such that the processing surfaces 8 and 10 of the upper 4 and lower 6 linear processing tools engage to process a web of material 28 at a flat angle when the lower linear processing tool 6 is at its uppermost position and the upper linear processing tool 4 is at its lowermost position.

Referring now to FIG. 1, each bracket 20, 22, 24, 26 are connected to a first 42 and second 44 crank. The first and second cranks 42, 44 are coupled to a rotary gear 34, 36, 40 or 42. The first crank 42 is interconnected with a hub 46 of the respective rotary gear 34, 36, 38, 40. The second crank 44 is connected to the respective rotary gear 34, 36, 38, 40 via a rotary arm 48. The incorporation of the cranks 42, 44 in conjunction with the rotary arms 48, help facilitate the movement of the linear processing tools 4, 6 such that they engage a web 28 at a flat angle to process the web and travel at the desired rate.

Still referring to FIG. 1, the design of the apparatus 2 is such that the plurality of rotary gears 14, 16, 18 are separated from the brackets 20, 22, 24, 26 and the linear processing tools 4, 6 by a pair of partitions 50 and 52. The partitions 50, 52 allow the plurality of rotary gears 14, 16, 18 to be contained in a separate environment to avoid debris contamination from the processing of the web 28. The first and second cranks 42, 44 span the width of the partition to enable the required movement of the apparatus 2 while allowing the rotary gears to be isolated from the working environment.

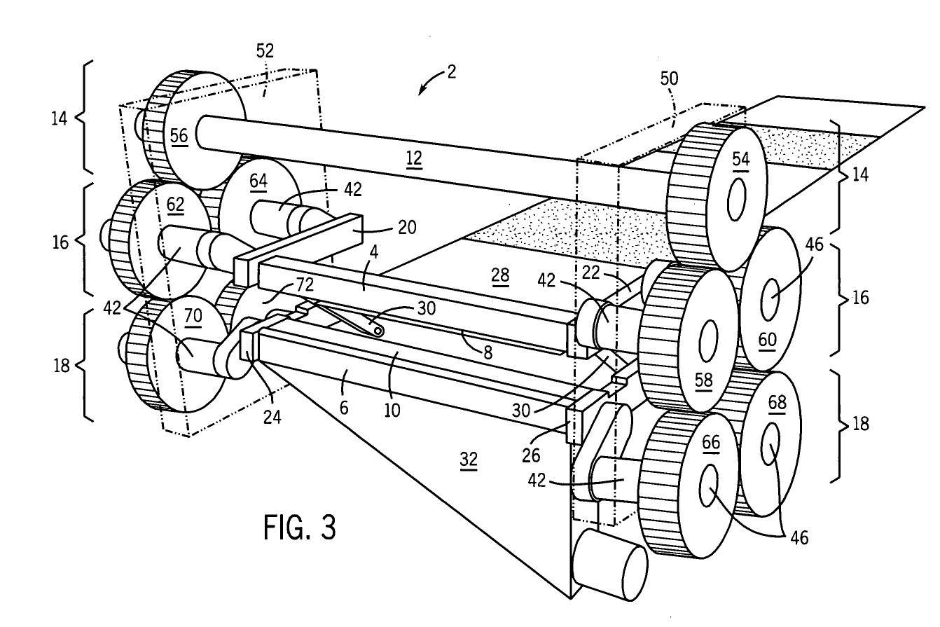

Referring now to FIG. 3, the processing interaction of the present invention may be achieved with several different types of tooling, bracketing and gear combinations. In the embodiment depicted in FIG. 3, a first set of rotary gears 14 are coupled to a drive shaft 12 and comprise a first 54 and second 56 rotary gear. Rotary gears 54 and 56 are horizontally spaced from one another and are connected by a drive shaft 12. The second set of rotary gears 16 comprises four rotary gears 58, 60, 62, 64. A first dyad comprising gears 58 and 60 are horizontally spaced from a second dyad comprising gears 62 and 64. This second set of rotary gears 16 are located vertically adjacent to and engage the first set of rotary gears 14. Further, the first dyad of gears 58/60 are connected to bracket 22, while the second dyad of gears 62/64 are connected to bracket 20.

The embodiment of FIG. 3 includes a third set of rotary gears 18 comprising four rotary gears 66, 68, 70, 72. Rotary gears 66 and 68 comprise a third dyad of gears while rotary gears 70 and 72 comprise a fourth dyad of gears. The third dyad of gears 66/68 are horizontally spaced from the fourth dyad of gears 70/72. The third set of rotary gears 18 are located vertically adjacent to and engage the second set of rotary gears 16. The third dyad of rotary gears 66/68 are connected to bracket 26, while the fourth dyad of gears 70/72 are connected to bracket 24.

The third dyad 66, 68 of the third set of gears 18 engages the first dyad 58/60 of the second set 16 of rotary gears, and the fourth dyad 70/72 of the third set of rotary gears 18 engages the second dyad 62/64 of the second set of rotary gears 16. Gear 54 of the first set of rotary gears 14 engages the first dyad 58/60 of the second set of rotary gears 16 and rotary gear 56 of the first set of rotary gears 14 engages the second dyad 62/64 of the second set of rotary gears 16 such that the first sets of rotary gears 14 impart movement on the second set of rotary gears 16 in an opposite direction as the movement of the first set of rotary gears 14, and, in turn, the second set of rotary gears 16 impart movement in the relative opposite direction on the third set of rotary gears 18. Thus, the first set of rotary gears 14 moves in the same direction as the third set of gears 18 while the second set of gears 16 moves in an opposite direction of the first 14 and third 18 sets of rotary gears.

Still referring to FIG. 3, brackets 20, 22 retain the upper tool 4 of the linear processing tools and brackets 24, 26 retain the lower tool 6 of the linear processing tools. As the brackets 20, 22, 24, 26 are connected to the respective dyads of gears 58/60, 62/64, 66/68, 70/72, as described above, the upper 4 and lower 6 linear processing tools rotate with the connected rotary gears 58, 60, 62, 64, 66, 68, 70, 72 such that the processing surfaces 8, 10 of the respective upper 4 and lower 6 linear processing tools engage to process a web of material 18 when the lower linear processing tool 6 is at its uppermost position and the upper linear processing tool 4 is at its lowermost position and at a desired rate.

Brackets 20, 22, 24, 26 are connected to cranks 42. Each crank 42 is connected to a hub 46 of a respective rotary gear 58, 60, 62, 64, 66, 68, 70, 72 such that each bracket 20, 22, 24, 26 is connected to a pair of cranks 42, and said pair of cranks are connected to a respective dyad of gears to effect movement on the upper 4 and lower 6 processing tools. The cranks 42 allow for separation of the sets of rotary gears 14, 16, 18 from the processing environment through partitions 50 and 52. Partitions 50 and 52 allow the plurality of rotary gears 14, 16, 18 to be contained in a separate environment to avoid debris contamination from the processing of the web 28. The cranks 42 span the width of the partition to enable the required movement of the apparatus 2 while allowing the rotary gears to be isolated from the working environment.

Referring now to FIG. 2, the web processing apparatus 2 of the embodiment depicted in FIG. 2 comprises a plurality of sets of rotary gears 14, 16, 18, these sets of rotary gears each comprising two rotary gears horizontally spaced from one another, the sets of rotary gears 14, 16, 18 being stacked vertically and engaging one another for coordinated movement. The apparatus 2 further comprises a drive shaft 12 coupled to the first set of rotary gears 14, the first set of rotary gears being functionally connected to the remaining sets of rotary gears 16, 18 such that the drive shaft 12 effects motion to the plurality of rotary gears 14, 16, 18. The drive shaft 12 is connected through a central axis of the first set of rotary gears 14. The upper linear processing tool 4 and lower linear processing tool 6 comprise interchangeable processing surfaces 8 and 10, respectively. The interchangeable processing surfaces 8 and 10 are capable of receiving various different types of processing plates for effecting the different types of processing on a web of material 28, as discussed above. Further, the processing surface 8 of the upper member 4 is adapted to engage the processing surface 10 of the lower member 6 at a flat angle to precisely process a web of material 28.

A plurality of brackets 20, 22, 24 and 26 connect the upper and lower linear processing tools to the remaining sets of rotary gears 16 and 18 via rectification gears 27. Rectification gears 27 operate to maintain the flat position of the upper and lower linear processing tools 4, 6, when the tools engage the web of material 28. Thus, bracket 20 attaches to the upper linear processing tool 4 and to the face of rotary gear 36. Bracket 22 is likewise attached to rotary gear 34. Bracket 24 is attached to the lower processing tool 6 and to the face surface of rotary gear 40, and bracket 26 is likewise attached to the face of rotary gear 38. The second set of rotary gears 16 is located vertically adjacent to both the upper set of rotary gears 14 and the lower set of rotary gears 18 and engage the first set 14 and the third set 18 for coordinated movement.

Still referring to FIG. 2, the web processing apparatus comprises a web guide member 30 to guide and maintain the web of material 28 when the web 28 is severed during certain types of processing. Preferably, the web guide member 30 maintain the web 28 in a horizontal plane between the processing surfaces 8 of the upper linear processing tool and 10 of the lower linear processing tool when the upper and lower tools engage to process a web of material 28. The web guide member 30 further operates to guide a leading edge of a severed web to downstream cylindrical rollers (not shown). The web guide member 30 as demonstrated in FIG. 2 is connected to the third set of rotary gears 18, such that the web guide member moves with the rotation of rotary gears 18. Thus, the web of material 28 is not constantly maintained at the precise vertical position, but is maintained at that position when the upper and lower tools engage for processing. In contrast, the web guide member 30 demonstrated in FIGS. 1 and 3 constantly maintains the web of material 28 at a precise vertical position in the horizontal plane between the upper linear processing tool 4 and the lower linear processing tool 6. The item of significant importance is that the web guide member 30, in all embodiments, maintains the web of material 28 in the horizontal plane between the upper and lower tools 4, 6 when the upper and lower tools engage the web for processing and, if the web is severed during processing, the web guide member 30 guides the leading edge of the severed web to the downstream cylindrical rollers.

When the drive shaft 12 drives the rotary motion of the plurality of sets of rotary gears 14, 16, 18, the rotary motion effects movement of the first set of gears 14 in a first direction. The movement of the first set of rotary gears 14 in the first direction effects movement of the second set of rotary gears 16 in the opposite direction. The movement of the second set of rotary gears 16 effects movement of the third set of rotary gears in the first direction that the first set of rotary gears 14 are traveling, which is opposite from the direction in which the second set of rotary gears 16 are moving. The movement of the second set of rotary gears 16 further effects movement of the upper member 4 of the linear processing tool in the second, opposite direction from the movement of the first rotary gear 14.

The movement of the third set of rotary gears 18 effects movement of the lower member 6 of the linear processing tool in the first direction that the first set of rotary gears 14 are moving such that the upper 4 and lower 6 members of the linear processing tool are moving in opposite directions but at the same rate as the web of material 28 is moving in between the processing surfaces 8, 10 of the respective members of the linear processing tool. Such effective movement allows the upper member 4 to engage the lower member 6 at the respective processing surfaces 8, 10 to effect processing on a web of material 28. The interaction of the upper member 4 and the lower member 6 takes place at a flat angle such that the processing of the web material 28 is precisely accomplished while operating at a high speed.

Referring now to FIGS. 4 and 5, the apparatus 2 of the present invention may further comprise a tooling support 33 for supporting either the upper linear processing tool 4 or the lower linear processing tool 6 and for providing increased processing pressure during the processing of the web of material 28. FIGS. 4 and 5 demonstrate the tooling support 33 being associated with the lower linear tool 6 and is designed for coordinated movement therewith. The tooling support 33 could also be associated with the upper linear processing tool 4 and is designed for coordinated movement therewith. The tooling support 33, as demonstrated in FIGS. 4 and 5, includes a support footing 74 connected to the lower linear processing tool 6. An additional rotary gear 76 is located adjacent to the plurality of rotary gears 14, 16, 18. The additional rotary gear 76 does not engage the plurality of sets of rotary gears, instead, a compensation gear 78 engages said plurality of rotary gears for coordinated movement of the additional rotary gear 78 with the plurality of rotary gears. Particularly, compensation gear 78 engages the third set of rotary gears 18 and allows for the additional rotary gear 76 to move in the same direction as the third set of rotary gears 18. An actuation shaft 80 is connected to the additional rotary gear 76. An articulation member 82 is connected to the actuation shaft 80 and further to the support footing 74. Thus, movement of the third set of rotary gears 18 imparts movement on the compensation gear 78, which in turn imparts movement on additional rotary gear 76. The movement of additional rotary gear 76 drives the movement of actuation shaft 80, which in turn drives movement of articulation member 82 for coordinated movement of the tooling support 33 with the lower linear processing tool 6 to promote increased processing pressure during the processing of a web of material 28. The same general construction would be used for a tooling support 33 associated with upper linear processing tool 4.

The articulation member 82 may comprise a cam and roller mechanism as demonstrated in FIG. 4, or may comprise a crank arm as demonstrated in FIG. 5. Additionally, the tooling support 33 may be independently powered for rotary movement in coordination with the lower linear tool 6. Regardless of the details of the construction, the tooling support of the present invention provides support through coordinated movement with either the upper 4 or lower 6 linear processing tool and further provides an increased processing pressure through such coordinated movement to more efficiently process a web of material using foil stamping, die cutting or other high pressure processes.

The method for high speed web processing of the present invention includes the steps of bracketing a pair of linear processing tools to a plurality of rotary gears such that the linear processing tools rotate with the rotary gears. The pair of linear processing tools comprise an upper linear processing tool and a lower linear processing tool. The method further comprises connecting the first set of rotary gears to a first set of brackets and connecting the second set of rotary gears to a second set of brackets. The upper linear processing tool is connected to the first set of brackets and the lower linear processing tool is connected to the second set of brackets.

The linear processing tools are aligned such that the upper and lower linear processing tools engage one another at a flat angle when the lower linear processing tool is at its uppermost position and the upper linear processing tool is at its lowermost position. This is accomplished when a first set of rotary gears are rotated in a first direction and a second set of rotary gears are rotated in a second direction, with the aforementioned plurality of rotating gears comprising the first and second sets of rotary gears.

The method of the present invention further comprises guiding a web of material at a precise vertical position in a horizontal plane between the upper and lower linear processing tools at a constant velocity, and processing a web of material when the upper and lower processing tools engage one another at a flat angle at the precise vertical position at which the web of material is guided. The processing step further includes engaging the web of material with the linear processing tools such that the horizontal velocity of the linear processing tools matches the horizontal velocity of the web of material. The step of guiding the web of material may further comprise: guiding the web of material when the web is severed by linear processing tools, wherein the web of material is guided in a horizontal plane between a pair of linear processing tools, engaging the web of material with the linear processing tools to sever the web of material, and guiding the leading edge of the severed web to downstream driven cylindrical rollers.

The method of the present invention includes many different types of processing. Therefore, the step of processing the web of material may comprise the steps of: perforating the web of material, creasing the web of material, punching the web of material, creasing the web of material, stamping the web of material, cutting the web of material, chipping the web of material, die cutting the web of material, embossing the web of material, foil stamping the web of material, or various other types of processing.

Some particular types of web processing require an increased processing pressure. Die cutting and foil stamping are examples of two types of processing which require high pressure. In order to provide such high pressure to the method of the present invention, a step of supporting the upper and/or lower linear processing tools with a support member is incorporated as a feature of the present invention. The incorporation of the supporting step allows for the processing step to process a web of material at an increased processing pressure.

The processing step of the method of the present invention may further comprise varying the rotational speed of the drive shaft to process the web in forms of different lengths from the same web of material. The step of varying the speed of the drive shaft includes connecting a servo motor to a drive shaft, the drive shaft driving the linear tools, programming a servo profile to control the servo motor at different speeds to produce forms of a certain length, driving the linear processing tools via the servo profile programmed for forms of a certain length, engaging the web of material with the linear processing tools such that the horizontal velocity of the linear processing tools matches the horizontal velocity of the web of material, disengaging the web of material, and driving the linear processing tools via the next programmed servo profile to process the web in forms of various sizes.

The processing step of the method of the present invention may further comprise fixing a rotational speed ratio of the drive shaft to the speed of the web to process the web of material in forms of a constant length from the same web of material. The step of fixing the rotational speed ratio of the drive shaft to the speed of the web includes connecting a motor to a drive shaft, the drive shaft driving the linear processing tools at a speed corresponding to the movement of the web of material through the linear processing tools, such that the horizontal velocity of the linear processing tools matches the horizontal velocity of the web of material, engaging the web of material with the linear processing tools and disengaging the web of material to process the web of material into forms of a constant length. The motor driving the drive shaft may be a servo motor or a conventional electric motor or any other motor as is well known in the art.

The processing step of the method of the present invention may further comprise varying the rotational speed of the drive shaft to process the web of material in forms of a constant length over a set period of time and subsequently varying the rotational speed of the drive shaft with a different velocity profile to process the web of material in forms of a second constant length for a given period of time. The step of varying the speed of the drive shaft includes connecting a servo motor to the drive shaft, the drive shaft driving the linear processing tools, programming a servo profile to control the servo motor, driving the linear processing tools via the servo profile for a certain length, engaging the web of material with the linear processing tools such that the horizontal velocity of the linear processing tools matches the horizontal velocity of the web of material, disengaging the web of material, and repeating this process over a set period of time to process the web in forms of a constant size for a set period of time. Processing a different form length would be achieved in the aforementioned manner of the method of the present invention, except that the servo profile would be programmed with different velocities corresponding to the different desired form lengths.

Finally, the method of the present invention may include the step of collecting debris from the processing step in a debris collection container.

It should be apparent from the scope in the art that the present invention as described contains several features, and that variations of the embodiments disclosed herein may be made which embody only some of the features disclosed herein. For example, many different types of interchangeable tooling may be used with the present invention to effect the variable processing advantage of the present invention. Also, the type of motor used to drive the apparatus may be varied. Further, numerous different types of gear, bracket and linear tool interactions may be assembled to achieve the processing of a web at a flat angle with a high rate of processing.

Various other combinations and modifications or alternatives may also be apparent to those skilled in the art. Such various alternatives and other embodiments are contemplated as being within the scope of the present invention.

1. A web processing apparatus comprising:
a pair of linear processing tools, said pair of linear processing tools further comprising an upper tool and a lower tool, both upper and lower tool having a processing surface;
a plurality of sets of rotary gears, said plurality of sets of rotary gears engaging one another for coordinated movement;
a drive shaft coupled to a first set of said rotary gears, said first set of rotary gears effecting movement of the remaining sets of rotary gears;
a plurality of brackets connecting said linear processing tools to said remaining sets of said rotary gears;
wherein said drive shaft drives movement of said linear processing tools at a same rate that a web to be processed moves in between said pair of linear processing tools, and wherein said processing surfaces of said pair of linear processing tools engage one another at a flat angle at a fixed position of said web to process said web.

2. The apparatus of claim 1, further comprising a web guide member to guide a web to be processed at a fixed position in between said pair of linear processing tools, relative to said lower tool.

3. The apparatus of claim 1, further comprising a debris collection bin located immediately below said lower tool.

4. The apparatus of claim 1, wherein said processing surfaces of said upper and lower linear processing tools are interchangeable.

5. The apparatus of claim 1, further comprising a tooling support for supporting either of said pair of linear processing tools during high pressure processing functions, said tooling support being associated with one of said linear processing tool and moving therewith.

6. The apparatus of claim 5, wherein the tooling support comprises a support footing connected to said tool, an additional rotary gear, a compensation gear engaging said additional rotary gear and further engaging said plurality of rotary gears for coordinated movement of said additional rotary gear with said plurality of rotary gears, an actuation shaft connected to said additional rotary gear, and an articulation member connected to said actuation shaft and said support footing, further wherein said tooling support provides support to said lower member through coordinated movement therewith.

7. The apparatus of claim 6, wherein said articulation member comprises a cam and roller mechanism.

8. The apparatus of claim 6, wherein said articulation member comprises a crank arm.

9. The apparatus of claim 1, wherein said plurality of sets of rotary gears and said plurality of brackets further comprises:
a first pair of rotary gears coupled to said drive shaft horizontally spaced from one another and connected by said drive shaft;
a second pair of rotary gears horizontally spaced from one another and connected to a first pair of brackets and located vertically adjacent to and engaging said first pair of rotary gears, such that said second pair of rotary gears rotate in an opposite direction as said first set of rotary gears;
a third pair of rotary gears horizontally spaced from one another and connected to a second pair of brackets and located vertically adjacent to and engaging said second pair of rotary gears such that said third pair of rotary gears rotate in the same direction as said first set of rotary gears;
wherein said first pair of brackets retain said upper tool of said pair of linear processing tools and said second pair of brackets retain said lower tool of said pair of linear processing tools such that said upper and lower linear processing tools rotate with said connected rotary gears and said processing surfaces of said upper and lower linear processing tools engage to process a web when the lower linear processing tool is at its uppermost position and the upper linear processing tool is at its lowest position.

10. The apparatus of claim 9, wherein each bracket of said first and second pairs of brackets are connected to a first and second crank, said first and second cranks being coupled to a rotary gear, wherein said first crank is interconnected with a hub of a rotary gear and said second crank is connected to a rotary gear via a rotary arm.

11. The apparatus of claim 10, wherein said rotary gears are separated from said plurality of brackets and said linear processing tools by a partition such that said rotary gears are contained in a separate environment to avoid debris contamination, wherein said first and second cranks span the width of said partition.

12. The apparatus of claim 1, wherein said plurality of sets of rotary gears and said plurality of brackets further comprises:
a first set of rotary gears coupled to said drive shaft, said first set of rotary gears comprising a first and second rotary gear horizontally spaced from one another and connected by said drive shaft;
a second set of rotary gears, said second set of rotary gears comprising four rotary gears, wherein a first dyad of gears of said second set of rotary gears are horizontally spaced from a second dyad of gears of said second set of rotary gears, wherein said second set of rotary gears are located vertically adjacent to said first set of rotary gears and are coupled to a first pair of brackets;
a third set of rotary gears, said third set of rotary gears comprising four rotary gears, wherein a third dyad of gears of said third set of rotary gears are horizontally spaced from a fourth dyad of gears of said third set of rotary gears, wherein said third set of rotary gears are located vertically adjacent to said second set of rotary gears and are coupled to a second pair of brackets;
wherein said third dyad of said third set of rotary gears engages said first dyad of said second set of rotary gears, said fourth dyad of said third set of rotary gears engages said second dyad of said second set of rotary gears, and wherein said first rotary gear of said first set of rotary gears engages said first dyad of said second set of rotary gears, and said second rotary gear of said first set of rotary gears engages said second dyad of said second set of rotary gears such that said first and third sets of rotary gears move in an opposite direction of said second set of rotary gears;
wherein said first pair of brackets retain said upper tool of said pair of linear processing tools and said second pair of brackets retain said lower tool of said pair of linear processing tools such that said upper and lower linear processing tools rotate with said connected rotary gears and said processing surfaces of said upper and lower linear processing tools engage to process a web when the lower linear processing tool is at its uppermost position and the upper linear processing tool is at its lowest position.

13. The apparatus of claim 12, wherein said first and second pairs of brackets are each connected to a pair of cranks, wherein each of said pair of cranks is interconnected with a hub of a rotary gear.

14. The apparatus of claim 13, wherein said rotary gears are separated from said plurality of brackets and said linear processing tools by a partition such that said rotary gears are contained in a separate environment to avoid debris contamination, wherein said pairs of cranks span the width of said partition.

15. The apparatus of claim 12, further comprising a tooling support for supporting said either of said pair of linear processing tools during high pressure processing functions, said tooling support being associated with one of said linear processing tools and moving therewith.

16. The apparatus of claim 15, wherein the tooling support comprises a support footing connected to said linear processing tool, an additional rotary gear, a compensation gear engaging said additional rotary gear and further engaging said third dyad of rotary gears for coordinated movement of said additional rotary gear with said third dyad of rotary gears, an actuation shaft connected to said additional rotary gear, and an articulation member connected to said actuation shaft and said support footing, further wherein said tooling support provides support to said lower member through coordinated movement therewith.

17. The apparatus of claim 16, wherein said articulation member comprises a cam and roller mechanism.

18. The apparatus of claim 16, wherein said articulation member comprises a crank arm.

19. A web processing apparatus comprising:
a plurality of sets of rotary gears, said sets of rotary gears each comprising two rotary gears horizontally spaced from one another, said sets of rotary gears being stacked vertically and engaging one another for coordinated movement;
a drive shaft coupled to a first set of said rotary gears, said first set of rotary gears being functionally connected to the remaining sets of rotary gears such that said drive shaft effects motion to said plurality of sets of rotary gears;
a linear processing tool comprising an upper member and a lower member, said upper and lower members each comprising a processing surface, wherein said processing surface of said upper member is adapted to engage said processing surface of said lower member at a flat angle to process a web of material;
a plurality of brackets connecting said linear processing tool to said remaining sets of said rotary gears, wherein an upper pair of said plurality of brackets engages said upper member of said linear processing tool and a lower pair of said plurality of brackets engages said lower member of said linear processing tool, and further wherein said upper pair of brackets is connected to a second set of rotary gears and said lower pair of brackets is connected to a third set of gears, said second and third sets of gears being located vertically adjacent to each other;
a web guide member to guide a web of material at a fixed position in between said processing surfaces of said upper and lower members of said linear processing tool;
wherein said drive shafts drives a rotary motion of said plurality of sets of rotary gears, said rotary motion effecting movement of said first set of rotary gears in a first direction, said movement of said first set of rotary gears effecting movement of said second set of rotary gears in a second direction, opposite of said first direction, and said movement of said second set of rotary gears effecting movement of said third set of rotary gears in said first direction;
wherein said movement of said second set of rotary gears effects movement of said upper member of said linear processing tool in said second direction, and said movement of said third set of rotary gears effects movement of said lower member of said linear processing tool in said first direction such that said upper and lower member of said linear processing tool are moving at the same rate as said web of material is moving in between said processing surfaces of said upper and lower members of said linear processing tool, and such that said processing surface of said upper member engages said processing surface of said lower member at a flat angle to process said web of material.

20. A method for high-speed web processing comprising the steps of:
bracketing a pair of linear processing tools to a plurality of rotary gears such that said linear processing tools rotate with said rotary gears, wherein said pair of linear processing tools comprise an upper linear processing tool and a lower linear processing tool and;
aligning said pair of linear processing tools such that said upper and lower linear processing tools engage at a flat angle when the lower linear processing tool is at its uppermost position and the upper linear processing tool is at its lowest position;
guiding a web of material in between said upper and lower linear processing tools at the same rate at which said linear tools are rotating;
processing said web of material when said upper and lower linear processing tools engage at a flat angle.

21. The method of claim 20 further comprising the step of driving said plurality of rotary gears with a drive shaft connected to a pair of drive shaft rotary gears, said drive shaft rotary gears engaging said plurality of rotary gears for coordinated movement.

22. The method of claim 20 further comprising the steps of rotating a first set of rotary gears in a first direction and rotating a second set of rotary gears in a second direction, wherein said plurality of rotary gears comprises said first and second sets of rotary gears.

23. The method of claim 22 wherein the step of bracketing a pair of linear processing tools to a plurality of rotary gears further comprises the steps of connecting said first set of rotary gears to a first set of brackets and connecting said second set of rotary gears to a second set of brackets, wherein said upper linear processing tool is connected to said first set of brackets and said lower linear processing tool is connected to said second set of brackets.

24. The method of claim 20, further comprising the step of supporting either of said linear processing tools and wherein said step of processing said web of material further comprises processing said web of material at an increased processing pressure.

25. The method of claim 20 wherein the step of processing said web of material further comprises perforating said web of material.

26. The method of claim 20 wherein the step of processing said web of material further comprises creasing said web of material.

27. The method of claim 20 wherein the step of processing said web of material further comprises punching said web of material.

28. The method of claim 20 wherein the step of processing said web of material further comprises cutting said web of material.

29. The method of claim 20 wherein the step of processing said web of material further comprises chipping said web of material.

30. The method of claim 20 wherein the step of processing said web of material further comprises embossing said web of material.

31. The method of claim 20 wherein the step of processing said web of material further comprises die cutting said web of material.

32. The method of claim 20 wherein the step of processing said web of material further comprises foil stamping said web of material.

33. The method of claim 20 further comprising the step of collecting debris from said processing step in a debris collection container.
